(19) United States
(12) Patent Application Publication
(10) Pub. No.: US 2024/0223947 A1
(43) Pub. Date: Jul. 4, 2024

(54) Audio Signal Processing Method and Audio Signal Processing System

(71) Applicant: Yamaha Corporation, Hamamatsu-shi (JP)

(72) Inventor: Tadashi MORIKAWA, Hamamatsu-shi (JP)

(21) Appl. No.: 18/605,935

(22) Filed: Mar. 15, 2024

Related U.S. Application Data
(63) Continuation of application No. PCT/JP2022/033267, filed on Sep. 5, 2022.

(30) Foreign Application Priority Data
Sep. 16, 2021 (JP) 2021-150761

(51) Int. Cl. H04R 3/02; H04R 3/00; H04R 3/12

(52) U.S. Cl. CPC H04R 3/02; H04R 3/005; H04R 3/12; H04R 2430/01

(57) ABSTRACT

An audio signal processing method includes providing a plurality of apparatuses and performing. The step of providing a plurality of apparatuses includes providing a plurality of sound collection apparatuses and a plurality of sound emission apparatuses corresponding to the plurality of sound collection apparatuses. The step of performing includes performing send level adjustment processing that sets a level of an audio signal of a sound collected by the plurality of sound collection apparatuses to a preset send level and sends the audio signal to the plurality of sound emission apparatuses. The send level adjustment processing changes a first send level to a minimum, the first send level being sent from a first sound collection apparatus that detects a talker voice, among the plurality of sound collection apparatuses, to a first sound emission apparatus closest to the first sound collection apparatus.

### CROSS-REFERENCE TO RELATED APPLICATIONS

This application is a continuation of PCT Application No. PCT/JP2022/033267, filed on Sep. 5, 2022, which claims priority to Japanese Application No. 2021-150761, filed on Sep. 16, 2021. The contents of these applications are incorporated herein by reference in their entirety.

### BACKGROUND

The present disclosure relates to an audio signal processing method and an audio signal processing apparatus when a sound collected by a microphone is emitted from a speaker.

Japanese Unexamined Patent Application Publication No. 2006-238254 and Japanese Unexamined Patent Application Publication No. 2018-142886 disclose an apparatus that significantly reduces howling.

Japanese Unexamined Patent Application Publication No. 2006-238254 discloses a loudspeaker system provided with a plurality of microphones and a plurality of speakers. The loudspeaker system disclosed in Japanese Unexamined Patent Application Publication No. 2006-238254 detects a talker based on an input signal from a plurality of microphones and selects a microphone corresponding to the position of the talker. The loudspeaker system of Japanese Unexamined Patent Application Publication No. 2006-238254 reduces the output level of the speaker placed near the selected microphone.

Japanese Unexamined Patent Application Publication No. 2018-142886 discloses a filter setting device provided with a plurality of microphones, a plurality of speakers, a mixer, an input filter, and an output filter. The filter setting device disclosed in Japanese Unexamined Patent Application Publication No. 2018-142886 adjusts the frequency characteristics of the output filter so as to change a loop gain of an integration system, with respect to an audio signal to be mixed by a mixer and outputted to the plurality of speakers.

However, in a configuration disclosed in Japanese Unexamined Patent Application Publication No. 2006-238254, for example, when a plurality of talkers at different positions talk simultaneously, the level of other talker voices to be outputted from the same speaker with a talker voice of which the speaker output is to be reduced is lowered. In other words, the loudspeaker system of Japanese Unexamined Patent Application Publication No. 2006-238254 unnecessarily lowers the level of a speaker output.

In addition, a configuration of Japanese Unexamined Patent Application Publication No. 2018-142886 requires complex signal processing.

### SUMMARY

In view of the above circumstances, an aspect of the present disclosure is directed to provide an audio signal processing method that is able to significantly reduce howling without requiring complex signal processing and appropriately output a voice other than a voice of which the howling is to be significantly reduced.

An audio signal processing method is used in an audio signal processing system including a plurality of sound collection apparatuses and a plurality of sound emission apparatuses corresponding to the plurality of sound collection apparatuses, performs send level adjustment processing that sets a level of an audio signal of a sound collected by each of the plurality of sound collection apparatuses to a preset send level and sends the audio signal to each of the plurality of sound emission apparatuses, and the send level adjustment processing changes a first send level to the minimum, the first send level being sent from a first sound collection apparatus that detects a talker voice, among the plurality of sound collection apparatuses, to a first sound emission apparatus closest to the first sound collection apparatus.

An audio signal processing method is able to significantly reduce howling without requiring complex signal processing and appropriately output a voice other than a voice of which the howling is to be significantly reduced.

### BRIEF DESCRIPTION OF THE DRAWINGS

FIG. 1 is a diagram showing an example of placement of a plurality of microphones and a plurality of speakers, in a space in which an audio conference is held;

FIG. 2 is a functional block diagram showing an example of a configuration of an audio signal processing system;

FIG. 3 is a flowchart showing an example of an audio signal processing method;

FIG. 4 is a functional block diagram showing an example of a configuration of a talker voice detector;

FIG. 5 is a functional block diagram showing an example of a configuration of a send level adjuster;

FIG. 6 is a table showing a relationship between a microphone and a speaker that are stored in a speaker DB;

FIG. 7 is a diagram showing an adjustment concept of a send level;

FIG. 8 is a diagram showing an adjustment concept of a send level;

FIG. 9A and FIG. 9B are diagrams showing an example of a magnitude of an output sound from the plurality of speakers;

FIG. 10 is a functional block diagram showing an example of a configuration of an audio signal processing system;

FIG. 11 is a functional block diagram showing an example of a configuration of a send level adjuster;

FIG. 12 is a flowchart showing an example of an audio signal processing method;

FIG. 13 is a functional block diagram showing an example of a configuration of an audio signal processing system;

FIG. 14 is a functional block diagram showing an example of a configuration of an audio signal processing system; and

FIG. 15 is a functional block diagram showing an example of a configuration of a conference apparatus used in an audio signal processing system.

### DETAILED DESCRIPTION

An audio signal processing method and an audio signal processing system according to an embodiment of the present disclosure will be described with reference to the drawings.

### First Embodiment

[Environment (Positional Relationship between Microphone, Speaker, and Talker) of Audio Conference]

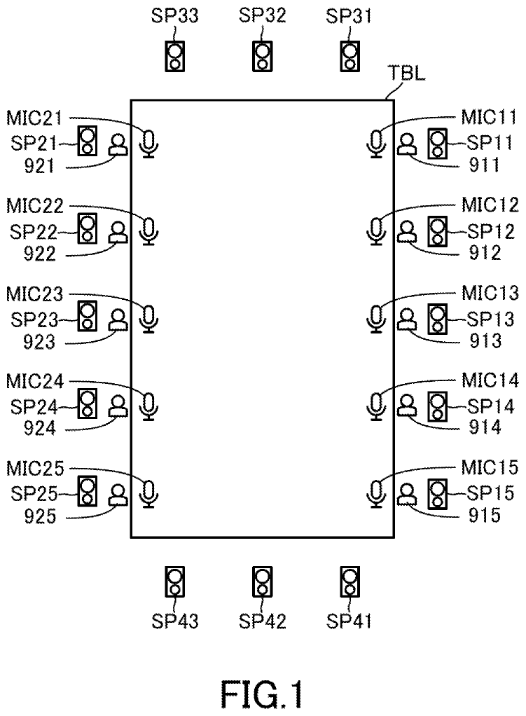

FIG. 1 is a diagram showing an example of placement of a plurality of microphones and a plurality of speakers, in a space in which an audio conference is held. As shown in FIG. 1, in a space (a conference room, for example) in which an audio conference is held, a plurality of microphones MIC11 to MIC25 (MIC11, MIC12, MIC13, MIC14, MIC15, MIC21, MIC22, MIC23, MIC24, MIC25), and a plurality of speakers SP11 to SP43 (SP11, SP12, SP13, SP14, SP15, SP21, SP22, SP23, SP24, SP25, SP31, SP32, SP33, SP41, SP42, SP43) are placed. These microphones correspond to “sound collection apparatuses” of the present disclosure, and these speakers correspond to “sound emission apparatuses” of the present disclosure.

The plurality of microphones MIC11 to MIC15, near a first side of a table TBL, are placed side by side along the first side. The plurality of microphones MIC21 to MIC25, near a second side (a side opposed to the first side) of the table TBL, are placed side by side along the second side. A line of the plurality of microphones MIC11 to MIC15 and a line of the plurality of microphones MIC21 to MIC25 are separated across the table TBL.

The plurality of speakers SP11 to SP15, near the first side of the table TBL, are placed side by side along the first side. The plurality of speakers SP21 to SP25, near the second side of the table TBL, are placed side by side along the second side. The speaker SP11 is a speaker closest to the microphone MIC11. Similarly, as shown in FIG. 1, the speakers SP12 to SP15 and SP21 to SP25 are speakers, respectively, closest to the microphones MIC12 to MIC15 and MIC21 to MIC25. As shown in FIG. 1, the plurality of speakers SP31 to SP33, near a third side (a side perpendicular to the first side and the second side) of the table TBL, are placed side by side along the third side. The plurality of speakers SP41 to SP43, near a fourth side (a side opposed to the third side) of the table TBL, are placed side by side along the fourth side. The plurality of speakers SP11 to SP43 each emit a sound mainly in a direction of a talker closest to each of the speakers. It is to be noted that, in FIG. 1, the plurality of speakers SP11 to SP43, although being not placed on the table TBL, may be placed on the table TBL.

The placement of these plurality of microphones and plurality of speakers is not limited to the example of FIG. 1. The placement of the plurality of microphones and the plurality of speakers may be placement that enables determination of the closest speaker to each microphone. In addition, the number of microphones to be placed and the number of speakers to be placed are not limited to the number of pieces described above, and are able to be set up according to the number of talkers that holds a conference, or the like.

A plurality of talkers 911 to 915 and 921 to 925 are present, respectively, near the plurality of microphones MIC11 to MIC15 and MIC21 to MIC25 and hold a conference (a conversation). More specifically, for example, the talker 911 is present near the microphone MIC11, and holds a conference, using the microphone MIC11. In such a case, the plurality of microphones MIC11 to MIC25 preferably collect the voice of a nearby talker and set directivity or the like so as to hardly collect the voice of other talkers.

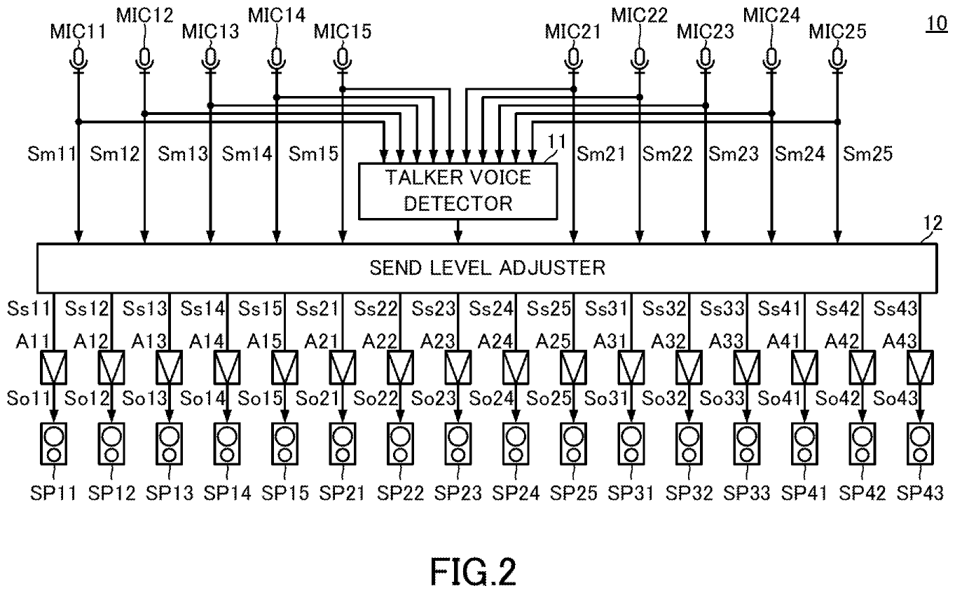

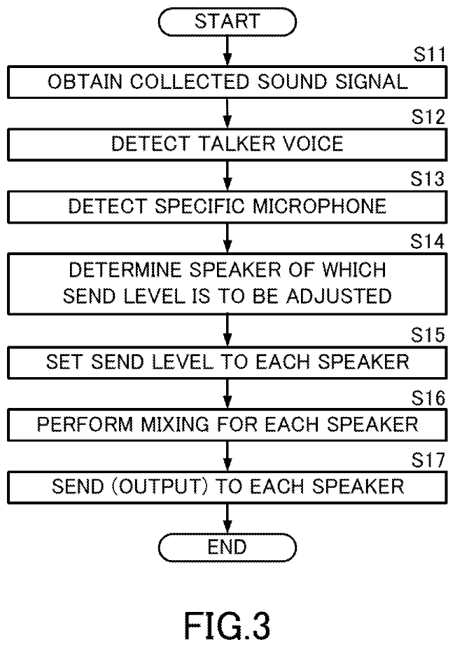

FIG. 2 is a functional block diagram showing an example of a configuration of an audio signal processing system according to the first embodiment of the present disclosure. FIG. 3 is a flowchart showing an example of an audio signal processing method according to the first embodiment of the present disclosure.

As shown in FIG. 2, an audio signal processing system 10 includes a talker voice detector 11, a send level adjuster 12, a plurality of microphones MIC11 to MIC25, a plurality of speakers SP11 to SP43, and a plurality of output amplifiers A11 to A43. The audio signal processing system 10 physically includes a main apparatus, a plurality of microphone housings, and a plurality of speaker housings.

The main apparatus is an information processing apparatus including a DSP, a CPU, or the like, a storage medium, and a predetermined electronic circuit. The main apparatus implements the function of the talker voice detector 11 and the send level adjuster 12 by executing an audio signal processing program stored in the storage medium by the DSP, the CPU, or the like. In addition, the main apparatus implements the plurality of output amplifiers A11 to A43 by a plurality of amplification devices.

The plurality of microphones MIC11 to MIC25 each include an individual microphone housing separated from the main apparatus. As shown in FIG. 1, the plurality of microphones MIC11 to MIC25 are placed at predetermined positions in a space in which a conference is held. The plurality of microphones MIC11 to MIC25 are physically and electrically connected to the main apparatus.

The plurality of speakers SP11 to SP43 each include an individual speaker housing separated from the main apparatus. As shown in FIG. 1, the plurality of speakers SP11 to SP43 are placed at predetermined positions in a space in which a conference is held. The plurality of speakers SP11 to SP43 are physically and electrically connected to the main apparatus.

More specifically, the audio signal processing system 10 includes the following circuit configuration.

The plurality of microphones MIC11 to MIC25 are connected to the talker voice detector 11 and the send level adjuster 12. The plurality of microphones MIC11 to MIC25 obtain a collected sound signal and output collected sound signals Sm11 to Sm25 to the talker voice detector 11 and the send level adjuster 12 (S11). Specifically, the microphone MIC11 outputs the collected sound signal Sm11 to the talker voice detector 11 and the send level adjuster 12. Similarly, the plurality of microphones MIC12 to MIC15 and MIC21 to MIC25 output the collected sound signals Sm12 to Sm15 and Sm21 to Sm25 to the talker voice detector 11 and the send level adjuster 12.

The talker voice detector 11 detects a talker voice, using the plurality of collected sound signals Sm11 to Sm25 (S12). In other words, the talker voice detector 11 detects a microphone that collects the voice of a talker who is pronouncing (talking). This microphone corresponds to a “first sound collection apparatus” of the present disclosure. In addition, this microphone is a specific microphone to be subject to send level adjustment, and is, hereinafter, referred to as a “specific microphone.”

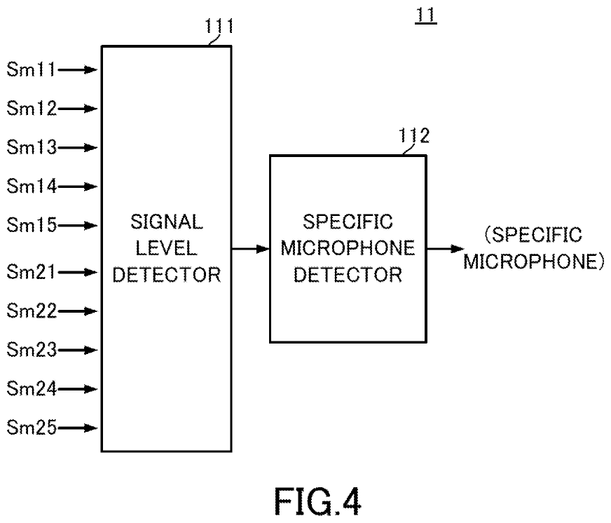

FIG. 4 is a functional block diagram showing an example of a configuration of the talker voice detector. As shown in FIG. 4, the talker voice detector 11 includes a signal level detector 111 and a specific microphone detector 112.

The signal level detector 111 receives an input of the collected sound signals Sm11 to Sm25 of the plurality of microphones MIC11 to MIC25. The signal level detector 111 detects the signal level (amplitude) of the plurality of collected sound signals Sm11 to Sm25. The signal level detector 111 outputs a signal level (amplitude) of the plurality of collected sound signals Sm11 to Sm25 to the specific microphone detector 112.

The specific microphone detector 112 stores a threshold value (hereinafter simply referred to as a threshold value) for talker detection in advance. The threshold value, for example, is a value higher than the noise level of the space in which a conference is held, and is set to a value lower than the level of the collected sound signal when a talk in the conference is collected by a microphone.

The specific microphone detector 112 compares the signal level of the plurality of collected sound signals Sm11 to Sm25 with the threshold value. The specific microphone detector 112 detects the collected sound signal equal to or greater than the threshold value. In other words, the specific microphone detector 112 detects the microphone that outputs the collected sound signal equal to or greater than the threshold value, as the specific microphone (S13). The specific microphone detector 112 outputs information on the specific microphone to the send level adjuster 12.

The send level adjuster 12 schematically adjusts the send level of the plurality of collected sound signals Sm11 to Sm25 with respect to the plurality of speakers SP11 to SP43, based on the specific microphone.

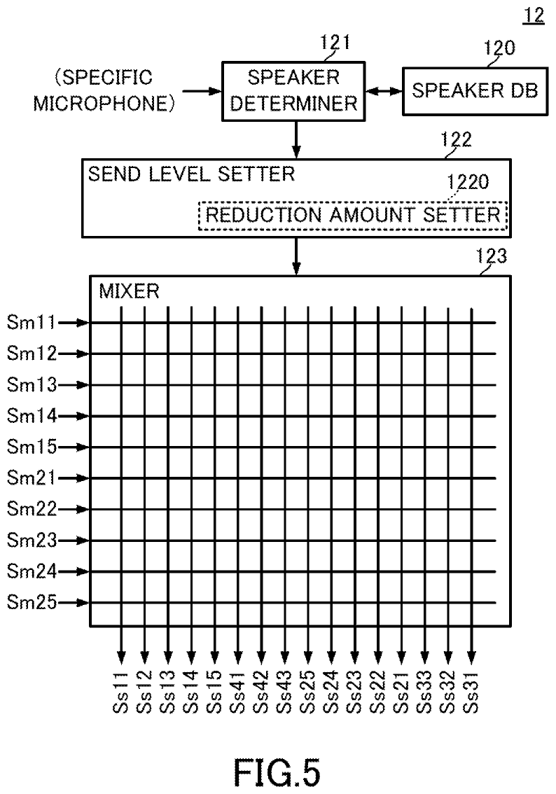

FIG. 5 is a functional block diagram showing an example of a configuration of the send level adjuster. As shown in FIG. 5, the send level adjuster 12 includes a speaker determiner 121, a send level setter 122, a mixer 123, and a speaker DB 120. The send level setter 122 includes a reduction amount setter 1220.

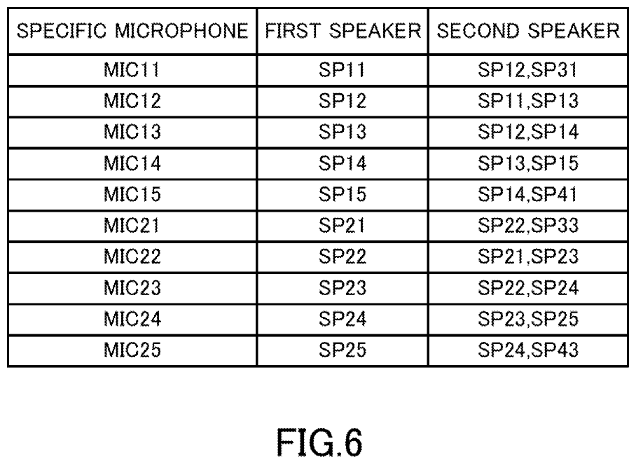

The speaker DB 120 stores a relationship between the specific microphone and a speaker of which the send level is to be adjusted. FIG. 6 is a table showing a relationship between the specific microphone and the speaker that are stored in the speaker DB 120. As shown in FIG. 6, a first speaker and a second speaker are associated for each specific microphone. The first speaker is a speaker closest to the specific microphone. The second speaker is a speaker second closest to the specific microphone after the first speaker. This first speaker corresponds to a “first sound emission apparatus” of the present disclosure, and the second speaker corresponds to a “second sound emission apparatus” of the present disclosure.

The speaker determiner 121 refers to the speaker DB 120 based on the information on the specific microphone and determines the speaker of which the send level is to be adjusted (S14). Specifically, the speaker determiner 121 refers to the speaker DB 120 based on the information on the specific microphone and determines the first speaker and the second speaker with respect to the specific microphone. For example, the speaker determiner 121, when the specific microphone is the microphone MIC13, determines the speaker SP13 as the first speaker, and determines the speakers SP12 and SP14 as the second speaker. The speaker determiner 121 outputs information on the first speaker and information on the second speaker to the send level setter 122.

The send level setter 122 sets a send level of the collected sound signal of the plurality of microphones MIC11 to MIC25 with respect to the plurality of speakers SP11 to SP43, based on the combination of the specific microphone, the first speaker, and the second speaker (S15). The send level with respect to the first speaker corresponds to a “first send level” of the present disclosure, and the send level with respect to the second speaker corresponds to a “second send level” of the present disclosure.

The send level setter 122, when no information that shows the combination of the specific microphone, the first speaker, and the second speaker is inputted, sets a preset send level with respect to all combinations of the plurality of microphones MIC11 to MIC25 and the plurality of speakers SP11 to SP43. The preset send level, although being basically the same in all the combinations of the plurality of microphones MIC11 to MIC25 and the plurality of speakers SP11 to SP43, is not limited to a perfect match but may include an error or an adjustment difference for each talker. Such a send level is called a reference send level. It is to be noted that the send level is an amount of adjustment of the signal level (amplitude) of an audio signal to be sent from a microphone to a speaker. The send level, for example, is able to be set by a gain with respect to a collected sound signal.

The send level setter 122, when the information that shows the combination of the specific microphone, the first speaker, and the second speaker is inputted, adjusts the send level from the specific microphone to the first speaker and the second speaker to be smaller than a reference send level. In such a case, the send level setter 122 uses a reduction amount set by a reduction amount setter 1220 to be described in detail below. More specifically, the send level setter 122 adjusts the send level from the specific microphone to the first speaker to the minimum value smaller than the reference send level. It is to be noted that the send level from the specific microphone to the first speaker may be 0. In other words, it is also possible not to send a collected sound signal from the specific microphone to the first speaker. In addition, the send level setter 122 adjusts the send level from the specific microphone to the second speaker to be smaller than the reference send level and larger than the send level to the first speaker. Then, the send level setter 122 sets the send level other than the send level from the specific microphone to the first speaker and the second speaker, to the reference send level.

The send level setter 122 outputs the send level for each combination of the plurality of microphones MIC11 to MIC25 and the plurality of speaker SP11 to SP43, to the mixer 123.

The mixer 123 is implemented by a so-called matrix mixer. The mixer 123, using the send level from the send level setter 122, adjusts a signal level of the collected sound signals Sm11 to Sm25 of the plurality of microphones MIC11 to MIC25, and performs mixing for each of the plurality of speakers SP11 to SP43 (S16).

For example, when all the collected sound signals Sm11 to Sm25 are not detected as a talker voice, the mixer 123 level-adjusts all the collected sound signals Sm11 to Sm25 by the reference send level. The mixer 123 mixes these collected sound signals that have been level-adjusted, for each of the plurality of speakers SP11 to SP43.

On the other hand, when a specific collected sound signal is detected as a talker voice, the mixer 123 level-adjusts the send level of the collected sound signal from the specific microphone to the first speaker and the second speaker to be smaller than the reference send level. The mixer 123 level-adjusts a send level other than the collected sound signal from the specific microphone to the first speaker and the second speaker, by the reference send level. The mixer 123 mixes these collected sound signals Sm11 to Sm25 that have been level-adjusted, for each of the plurality of speakers SP11 to SP43.

The mixer 123, by performing such mixing processing, generates speaker supply signals Ss11 to Ss43 with respect to each of the plurality of speaker SP11 to SP43.

As a result, the level at which the collected sound signal of the specific microphone is outputted from the first speaker becomes significantly smaller. In addition, the level at which the collected sound signal of the specific microphone is outputted from the second speaker becomes smaller. Therefore, howling via the specific microphone is able to be significantly reduced. On the other hand, the level at which the collected sound signal of the specific microphone is outputted from speakers other than the first speaker and the second speaker is able to be ensured to a level at which other talkers can hear.

The send level adjuster 12 sends (outputs) the speaker supply signals Ss11 to Ss43, respectively, to the output amplifiers A11 to A43. The output amplifiers A11 to A43 each amplify the speaker supply signals Ss11 to Ss43 and generates speaker driving signals Soll to So43. The output amplifiers A11 to A43 send (output) the speaker driving signals Soll to So43, respectively, to the plurality of speakers SP11 to SP43 (S17).

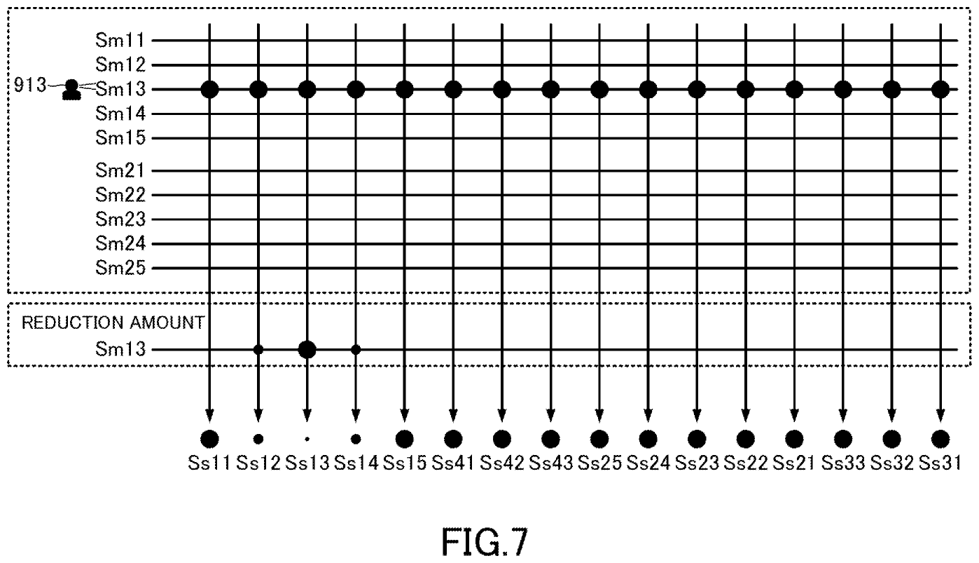

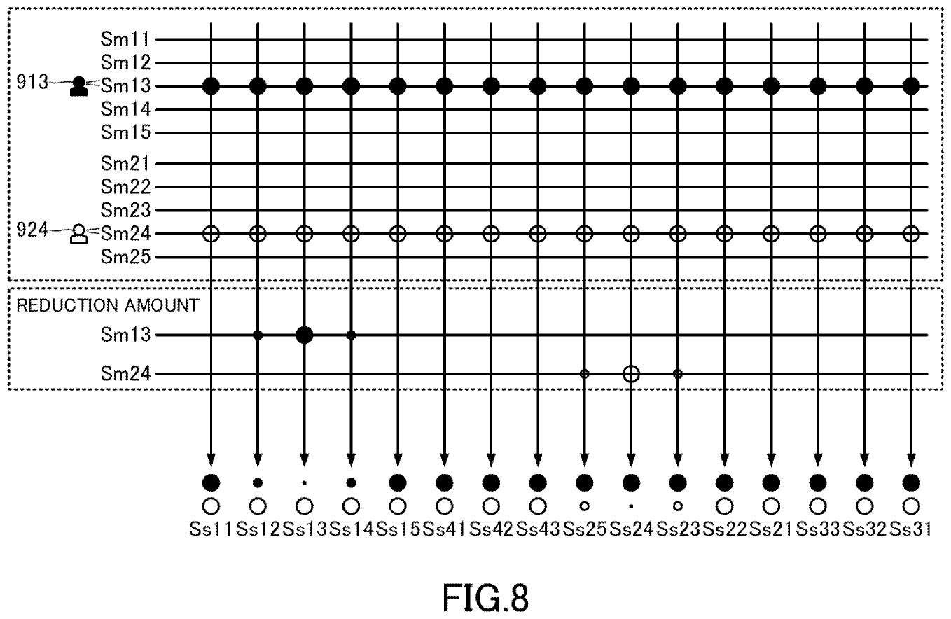

It is to be noted that the processing of the send level adjuster 12 is processing as a way to implement the next concept. FIG. 7 and FIG. 8 are diagrams showing an adjustment concept of the send level according to the embodiment of the present disclosure. FIG. 7 shows a case of one talker who is talking. FIG. 8 shows a case of two talkers who are simultaneously talking. The magnitude of black circles in FIG. 7 and FIG. 8 and the magnitude of white circles in FIG. 8 show the magnitude of a send level.

As shown in FIG. 7, when only a talker 913 is talking, in the plurality of collected sound signals Sm11 to Sm25, the signal level of the collected sound signal Sm13, when being equal to or greater than the threshold value, serves as the maximum value, and the signal level of other collected sound signals is less than the threshold value.

The send level adjuster 12, with respect to the collected sound signal Sm13 by the talk of the talker 913, sets the send level to all the speakers to the reference send level. In other words, as shown in the black circles of FIG. 7, the send level adjuster 12 sets the same send level to all the speakers SP11 to SP43, with respect to the collected sound signal Sm13.

The send level adjuster 12 further adds the following processing. The send level adjuster 12, based on the microphone MIC13 detected as the specific microphone, determines the speaker SP13 as the first speaker, and determines the speakers SP12 and SP14 as the second speaker. The send level adjuster 12 sets a reduction amount of the collected sound signal Sm13 with respect to the speaker SP13, the speaker SP12, and the speaker SP14, and does not set a reduction amount to other speakers.

More specifically, the send level adjuster 12 sets the reduction amount with respect to the combination of the microphone MIC13 (the specific microphone) and the speaker SP13 (the first speaker), as shown in FIG. 7, to be approximately equal to, for example, the reference send level. The send level adjuster 12 sets the reduction amount with respect to the combination of the microphone MIC13 (the specific microphone) and the speakers (the second speakers) SP12 and SP14, as shown in FIG. 7, to be smaller than the reference send level and to be a value that is not 0. It is to be noted that, herein, the reduction amount is set as reference of the concept of the invention in the present application. However, the send level adjuster 12 does not set the reduction amount, but may simplify processing by simply making the send level small with respect to the combination of the specific microphone, the first speaker, and the second speaker.

In such a case, the send level adjuster 12 more preferably performs the following processing. The send level adjuster 12 specifically sets the reduction amount by the next concept. The send level adjuster 12 defines the gain corresponding to the reference send level as a gain A, and defines a degree of reduction as a reduction index a. In addition, the send level adjuster 12 defines a distance between the microphone MIC13 and the speaker SP13 as a distance r1, and defines a distance between the microphone MIC13 and the speakers SP12 and SP14 as a distance r2. Moreover, the send level adjuster 12 defines a degree of influence of the distance on the reduction amount as a degree n of influence.

In this case, the reduction amount with respect to the speaker SP13 is set to A/(r1ⁿ·α). In addition, the reduction amount with respect to the speakers SP12 and SP14 is set to A/(r2ⁿ·α). As a result, the send level adjuster 12 is able to set the reduction amount as described above. Such reduction amounts serve as values according to the positional relationship between the plurality of speakers and the plurality of microphones.

The send level adjuster 12, by subtracting the reduction amount from the reference send level, sets the send level with respect to all the speakers SP11 to SP43. Accordingly, the send level adjuster 12 makes the send level of the collected sound signal Sm13 with respect to the speaker SP13 smaller than the reference send level and adjusts the send level to the minimum value. In addition, the send level adjuster 12 adjusts the send level of the collected sound signal Sm13 with respect to the speakers SP12 and SP14 to be smaller than the reference send level. Furthermore, the send level adjuster 12 sets the send level of the collected sound signal Sm13 with respect to speakers other than the speakers SP12, SP13, and the SP14, as the reference send level.

As shown in FIG. 8, when the talker 913 and a talker 924 are simultaneously talking and other talkers are not talking, the signal level of the collected sound signals Sm13 and Sm24 is equal to or greater than the threshold value, and the signal level of other collected sound signals is less than the threshold value.

The send level adjuster 12, with respect to the collected sound signal Sm13 and the collected sound signal Sm24, sets the send level to all the speakers to the reference send level. In other words, as shown in the black circles of FIG. 8, the send level adjuster 12 sets the same send level to all the speakers SP11 to SP43, with respect to the collected sound signal Sm13. In addition, as shown in the white circles of FIG. 8, the send level adjuster 12 sets the same send level to all the speakers SP11 to SP43, with respect to the collected sound signal Sm24.

The send level adjuster 12 further adds the following processing. The send level adjuster 12, based on the microphone MIC13 detected as the specific microphone, determines the speaker SP13 as the first speaker, and determines the speakers SP12 and SP14 as the second speaker. The send level adjuster 12 sets the reduction amount of the collected sound signal Sm13 with respect to the speaker SP13, the speaker SP12, and the speaker SP14. The send level adjuster 12 does not set a reduction amount to other speakers.

More specifically, the send level adjuster 12 sets the reduction amount with respect to the combination of the microphone MIC13 and the speaker SP13 (the first speaker), as shown in FIG. 8, to be approximately equal to, for example, the reference send level. The send level adjuster 12 sets the reduction amount with respect to the combination of the microphone MIC13 and the speakers (the second speakers) SP12 and SP14, as shown in FIG. 8, to be smaller than the reference send level and to be a value that is not 0. It is to be noted that, herein as well, the reduction amount is set as reference of the concept of the invention in the present application. However, similarly to the above case, the send level adjuster 12 does not set the reduction amount, but may simplify processing by simply making the send level small.

The send level adjuster 12, based on the microphone MIC24 detected as the specific microphone, determines the speaker SP24 as the first speaker, and determines the speakers SP23 and SP25 as the second speaker. The send level adjuster 12 sets the reduction amount of the collected sound signal Sm24 with respect to the speaker SP24, the speaker SP23, and the speaker SP25. The send level adjuster 12 does not set a reduction amount with respect to other speakers.

More specifically, the send level adjuster 12 sets the reduction amount with respect to the combination of the microphone MIC24 and the speaker SP24 (the first speaker), as shown in FIG. 8, to be approximately equal to, for example, the reference send level. The send level adjuster 12 sets the reduction amount with respect to the combination of the microphone MIC24 and the speakers (the second speakers) SP23 and SP25, as shown in FIG. 8, to be smaller than the reference send level and to be a value that is not 0. It is to be noted that, herein as well, the reduction amount is set as reference of the concept of the invention in the present application. However, similarly to the above case, the send level adjuster 12 does not set the reduction amount, but may simplify processing by simply making the send level small.

The send level adjuster 12, by subtracting the reduction amount from the reference send level, sets a send level with respect to all the speakers SP11 to SP43. Accordingly, as shown in FIG. 8, the send level adjuster 12 makes the send level of the collected sound signal Sm13 with respect to the speaker SP13 smaller than the reference send level and adjusts the send level to the minimum value. In addition, the send level adjuster 12 adjusts the send level of the collected sound signal Sm13 with respect to the speakers SP12 and SP14 to be smaller than the reference send level. Furthermore, the send level adjuster 12 sets a send level of the collected sound signal Sm13 with respect to speakers other than the speakers SP12, SP13, and the SP14, as the reference send level. Moreover, the send level adjuster 12 makes the send level of the collected sound signal Sm24 with respect to the speaker SP24 smaller than the reference send level and adjusts the send level to the minimum value. In addition, the send level adjuster 12 adjusts the send level of the collected sound signal Sm24 with respect to the speakers SP23 and SP25 to be smaller than the reference send level. Furthermore, the send level adjuster 12 sets the send level of the collected sound signal Sm24 with respect to speakers other than the speakers SP23, SP24, and SP25, as the reference send level.

Therefore, in the speaker supply signal Ss13, the component of the collected sound signal Sm13 is significantly reduced. On the other hand, in the speaker supply signal Ss13, the component of the collected sound signal Sm24 is not reduced. In addition, in the speaker supply signals Ss12 and Ss14, the component of the collected sound signal Sm13 is reduced to some extent. On the other hand, in the speaker supply signals Ss12 and Ss14, the component of the collected sound signal Sm24 is not reduced.

As a result, howling by the microphone MIC13 and the plurality of speakers SP13, SP12, and SP14 is significantly reduced. Furthermore, the talker 913 can clearly catch the talk of the talker 924 also during the own talk.

Similarly, in the speaker supply signal Ss24, the component of the collected sound signal Sm24 is significantly reduced. On the other hand, in the speaker supply signal Ss24, the component of the collected sound signal Sm13 is not reduced. In addition, in the speaker supply signals Ss23 and Ss25 to the speakers SP23 and SP25, the component of the collected sound signal Sm24 is reduced to some extent. On the other hand, in the speaker supply signals Ss23 and Ss25, the component of the collected sound signal Sm13 is not reduced.

As a result, howling by the microphone MIC24 and the plurality of speakers SP24, SP23, and SP25 is significantly reduced. Furthermore, the talker 924 can clearly catch the talk of the talker 913 also during the own talk.

It is to be noted that, when a plurality of functional blocks implement the processing shown in FIG. 7 and FIG. 8, for example, the send level setter 122 shown in FIG. 5 includes a reduction amount setter 1220. The reduction amount setter 1220 sets the reduction amount as described above, using the specific microphone determined by the speaker determiner 121 and the pair of the first speaker and the second speaker. The send level setter 122, by subtracting from the reference send level the reduction amount that has been set by the reduction amount setter 1220, sets the send level with respect to the combination of all the microphones and speakers.

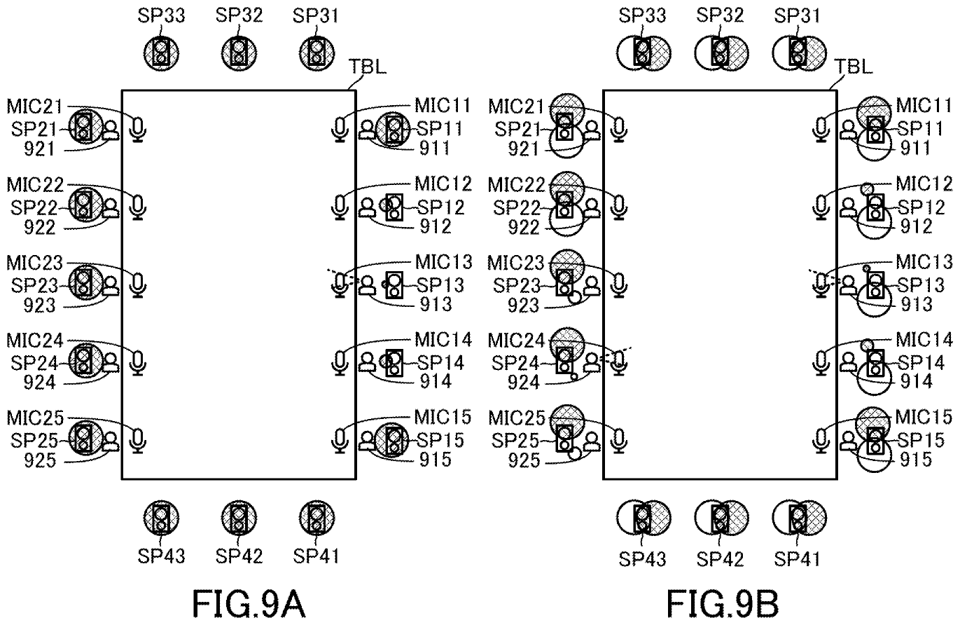

With the above configuration and processing, the audio signal processing system 10, as shown in FIG. 9A and FIG. 9B, is able to emit a sound of the talk of a talker from the plurality of speakers SP11 to SP43.

FIG. 9A and FIG. 9B are diagrams showing an example of a magnitude of an output sound from the plurality of speakers. FIG. 9A and FIG. 9B are the same as FIG. 1 in placement of the plurality of microphones, the plurality of speakers, and the plurality of talkers. FIG. 9A shows a case in which only the talker 913 has spoken and FIG. 9B shows a case in which the talker 913 and the talker 924 have spoken simultaneously. In FIG. 9A and FIG. 9B, a hatched circle shows the volume of each speaker when the plurality of speakers SP11 to SP43 emit the voice of the talker 913 and means that the volume is increased as the radius of the circle is increased. In FIG. 9B, an unfilled circle shows the volume of each speaker when the plurality of speakers SP11 to SP43 emit the voice of the talker 924 and means that the volume is increased as the radius of the circle is increased.

As shown in FIG. 9A, when the talker 913 is talking, the volume of the speaker SP13 is the smallest and the volume of the speakers SP12 and SP14 is next small. Then, the volume of the other speakers SP11, SP15, and SP21 to SP43 serves as a larger predetermined value than the volume of the speakers SP12 to SP14. As a result, the volume of the voice of the talker 913 that propagates from the speaker SP13 to the microphone MIC13 is reduced, and is able to significantly reduce howling. Furthermore, the volume of the voice of the talker 913 that propagates from the speakers SP12 to SP14 to the microphone MIC13 is reduced, and is able to further significantly reduce howling.

In such a case, the volume of the speakers SP12 and SP14 is larger than the volume of the speaker SP13. Therefore, the talker 912 and the talker 914 can hear a direct sound from the talker 913 and the voice of the talker 913 outputted from the speakers SP12 and SP14. Therefore, according to the present embodiment, inaudibility of the voice of the talker 913 is able to be significantly reduced.

As shown in FIG. 9B, when the talker 913 and the talker 924 are talking simultaneously, various types of processing regarding the voice of the talker 913 are as described above, which significantly reduces howling by the voice of the talker 913. On the other hand, as shown in FIG. 9B, the speaker SP24 near the talker 924 who is talking simultaneously with the talker 913 emits a sound without significantly reducing the voice of the talker 913. As a result, the talker 924, while being talking, can hear the voice of the talker 913 from the speaker SP24.

In addition, similarly to the case of the talker 913, as shown in the unfilled circle in FIG. 9B, the volume of the speaker SP24 with respect to an audio signal from the microphone MIC24 is the smallest, and the volume of the speakers SP23 and SP25 is next small. Then, the volume of the other speakers SP11 to SP15, SP21, SP22, and SP31 to SP43 serves as a larger predetermined value than the volume of the speakers SP23 to SP25. As a result, the volume of the voice of the talker 924 that propagates from the speaker SP24 to the microphone MIC24 is reduced, and is able to significantly reduce howling. Furthermore, the volume of the voice of the talker 924 that propagates from the speakers SP23 and SP25 to the microphone MIC24 is reduced, and is able to further significantly reduce howling.

In addition, as shown in FIG. 9B, the speaker SP13 emits a sound without significantly reducing the volume of an audio signal including the voice of the talker 924. Accordingly, the talker 913, while being talking, can hear the voice of the talker 924 from the speaker SP13.

In such a manner, the audio signal processing system 10, in the simultaneous talk of a plurality of talkers, while enabling each talker to clearly catch the voice of other talkers, is also able to significantly reduce each howling. It is to be noted that, although the above description shows the case in which two persons talk simultaneously, the same processing is able to be applied also to a case in which three or more persons talk simultaneously.

It is to be noted that, in the prior art, when the above howling is significantly reduced, the output of the plurality of speakers SP11 to SP43 is significantly reduced. In other words, the configuration of the prior art adjusts the volume of the speaker driving signals Soll to So43. In such a case, when the plurality of talkers are talking simultaneously, a sound outputted from the speaker near one talker is a sound obtained by also reducing the voice of other talkers who are talking. Therefore, the talker is difficult to clearly catch the voice of other talkers who are talking simultaneously.

As described above, the audio signal processing system 10 significantly reduces howling and is able to appropriately output a voice other than a voice of which the howling is to be significantly reduced. In addition, the audio signal processing system 10 does not perform setting, or the like, of complex filter coefficients for significantly reducing howling, and does not require complex signal processing for significantly reducing howling.

It is to be noted that the above description shows the case of one talker or the case (the case in which the plurality of talkers are separated from each other) of one talker in each of the plurality of lines. However, when the plurality of talkers (simultaneous talkers) are close to each other, the audio signal processing system 10, using the following method, for example, significantly reduces howling and is able to appropriately output the voice other than the voice of which the howling is to be significantly reduced.

For example, the specific microphone detector 112, when the plurality of collected sound signals are equal to or greater than the threshold value, compares the waveforms or the like of these collected sound signals, and detects whether the plurality of collected sound signals are voices of the same talker. The specific microphone detector 112, when the plurality of collected sound signals are voices of different talkers, detects a plurality of specific microphones corresponding to each of the plurality of collected sound signals. The send level adjuster 12 performs the above send level adjustment processing, based on the plurality of specific microphones. It is to be noted that, in such a case, the specific microphone detector 112, when the plurality of collected sound signals are voices of the same talker, detects the microphone corresponding to the collected sound signal of the maximum value, as the specific microphone. Then, the send level adjuster 12 performs the above send level adjustment processing, based on this specific microphone.

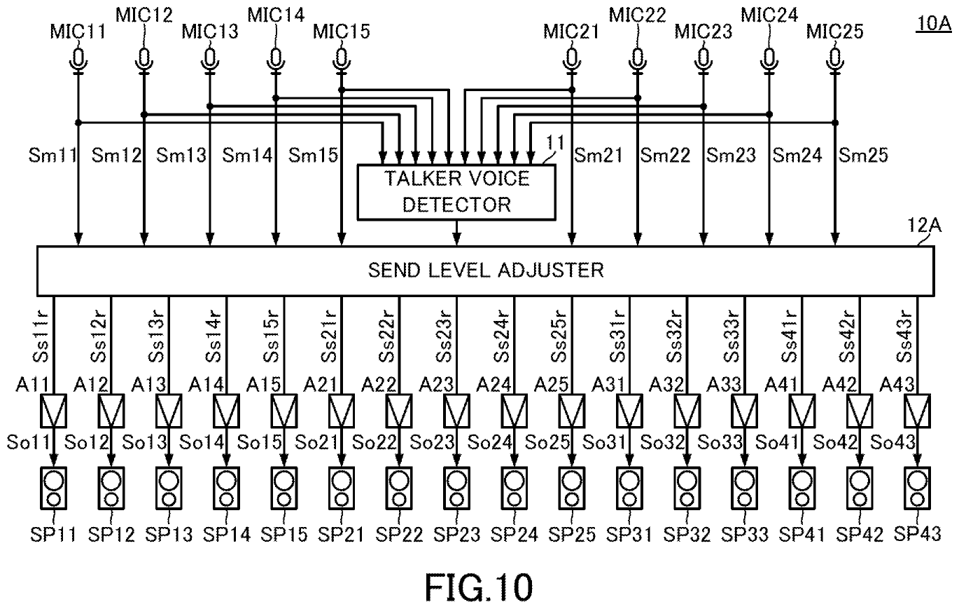

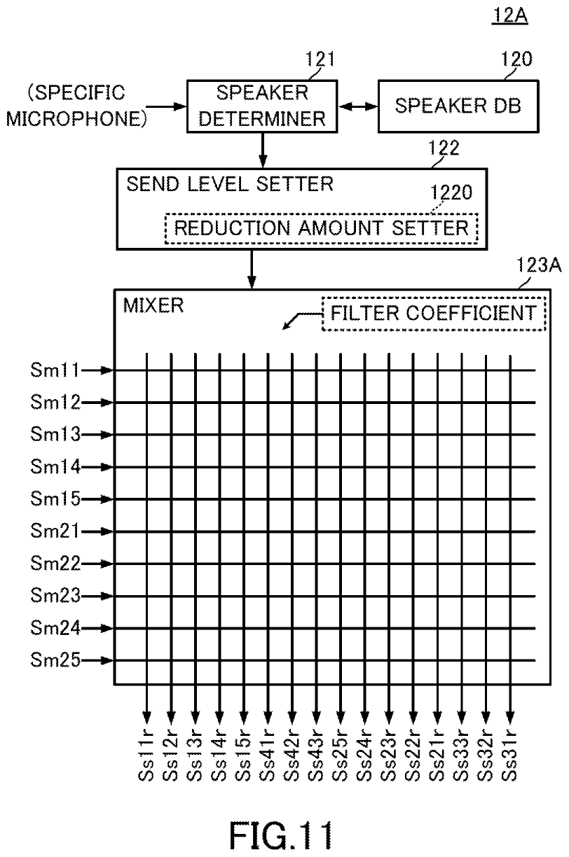

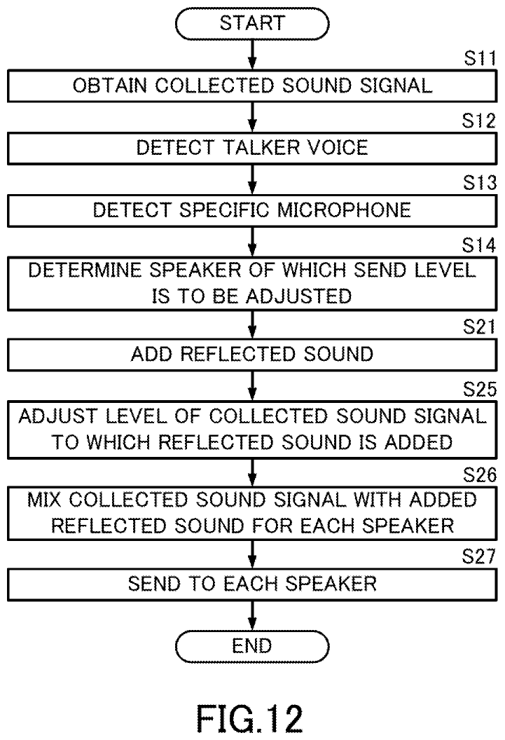

FIG. 10 is a functional block diagram showing an example of a configuration of an audio signal processing system according to a second embodiment of the present disclosure. FIG. 11 is a functional block diagram showing an example of a configuration of a send level adjuster according to the second embodiment. FIG. 12 is a flowchart showing an example of an audio signal processing method according to the second embodiment of the present disclosure.

An audio signal processing system 10A according to the second embodiment is different from the audio signal processing system 10 according to the first embodiment in that a send level adjuster 12A is provided in place of the send level adjuster 12. Other configurations of the audio signal processing system 10A are the same as or similar to the configurations of the audio signal processing system 10, and a description of the same or similar configurations will be omitted.

The send level adjuster 12A is different from the send level adjuster 12 according to the first embodiment in that a mixer 123A is provided in place of the mixer 123. Other configurations of the send level adjuster 12A are the same as or similar to the configurations of the send level adjuster 12, and a description of the same or similar configurations will be omitted.

As shown in FIG. 11, the mixer 123A, similarly to the mixer 123 according to the first embodiment, is implemented by a matrix mixer. However, the mixer 123A includes a filter that adds a reflected sound to each combination of the plurality of microphones MIC11 to MIC25 and the plurality of speaker SP11 to SP43. The filter that adds a reflected sound is an FIR filter or the like, for example.

Specifically, the mixer 123A receives an input of a plurality of collected sound signals Sm11 to Sm25. The mixer 123A performs convolution calculation processing by the filter coefficient according to each of the plurality of speakers SP11 to SP43 with respect to the plurality of collected sound signals Sm11 to Sm25. As a result, the mixer 123A adds a plurality of reflected sounds to each combination of the plurality of microphones MIC11 to MIC25 and the plurality of speaker SP11 to SP43 (S21). In such a case, the mixer 123A sets the filter coefficient of the convolution calculation processing, based on each positional relationship between the plurality of microphones MIC11 to MIC25 and the plurality of speaker SP11 to SP43, and the environment (the size of a conference room, the structure of a wall or a ceiling, or the like) of a conference room.

The filter coefficient of the convolution calculation processing is set as follows, for example. The reflected sound is configured by an early reflected sound component and a reverberant sound component. The early reflected sound is a sound that reaches a sound receiving point at an early time after the sound generated at a generation position (a talker position) is reflected off a wall, a floor, and a ceiling. Therefore, the filter coefficient of the convolution calculation processing for the early reflected sound component is set based on the position of a talker (the position of a microphone), the position of a speaker, and the environment (the size of a conference room, the structure of a wall or a ceiling, or the like) of a conference room. The reverberant sound is a sound that reaches the sound receiving point after the sound generated at the generation position is reflected multiple times, and reaches the sound receiving point following the early reflected sound. Therefore, the filter coefficient of the convolution calculation processing for a reverberant sound component is set based on the environment (the size of a conference room, the structure of a wall or a ceiling, or the like) of a conference room. It is to be noted that the method of setting these early reflected sound component and reverberant sound component is an example and another setting method is also able to be used. These early reflected sound and reverberant sound each correspond to an “indirect sound” of the present disclosure.

At the time of addition of such a reflected sound, the mixer 123A adjusts the level of the collected sound signal to which the reflected sound is added, using the send level that has been set by the send level setter 122 (S25). For example, the mixer 123A sets a coefficient that adjusts an amplitude level based on the send level, and multiplies the coefficient by the collected sound signal to which the reflected sound is added. As a result, the mixer 123A is able to generate a collected sound signal of which the amplitude level is adjusted by the send level and to which the reflected sound is added.

The mixer 123A mixes collected sound signals of which the amplitude level is adjusted by the send level and to which the reflected sound is added, for each of the plurality of speakers SP11 to SP43 (S26). Accordingly, the mixer 123A generates speaker supply signals Ss11r to Ss43r for each of the plurality of speakers SP11 to SP43, and outputs the signals to the plurality of output amplifiers A11 to A43. The plurality of output amplifiers A11 to A43 send the speaker supply signals Ss11r to Ss43r to the plurality of speakers SP11 to SP43 (S27).

By such a configuration, the audio signal processing system 10A is able to provide each talker with a sound with presence according to the environment of a conference room, the position of a talker, and the position of each speaker, from the plurality of speakers SP11 to SP43, while producing the same functions and effects as the audio signal processing system 10.

The reflected sound may include at least one of the early reflected sound components or the reverberant sound component. In such a case, by using the reverberant sound component, the audio signal processing system 10A is able to implement conversation with presence according to the shape of a conference room, the state of a wall surface, or the like. In addition, by using the early reflected sound component, the audio signal processing system 10A is able to implement conversation with presence according to the position of a talker and the position of a listener (another talker who hears the voice of a talker who is talking) in a conference room.

In the above configuration, the audio signal processing system 10A adds a reflected sound to each combination of a plurality of microphones and a plurality of speakers. However, the audio signal processing system 10A, for example, is also able to add a reflected sound as follows. The audio signal processing system 10A divides the plurality of microphones and the plurality of speakers into a plurality of groups according to each position. The audio signal processing system 10A adds a reflected sound to each combination of a plurality of microphone groups and a plurality of speaker groups. Accordingly, the audio signal processing system 10A is able to reduce a load of signal processing, while adding presence.

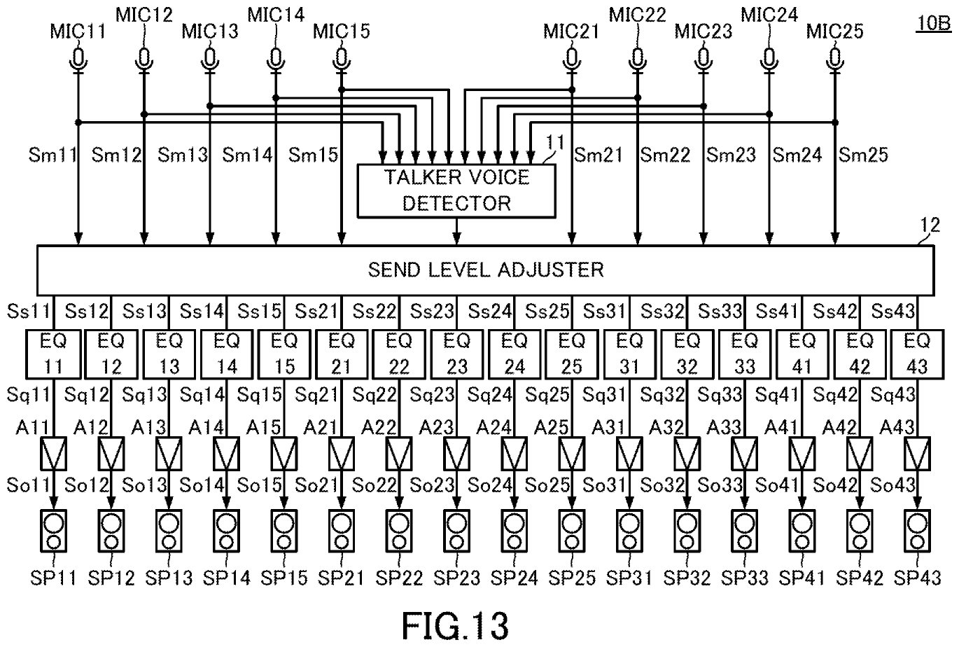

FIG. 13 is a functional block diagram showing an example of a configuration of an audio signal processing system according to a third embodiment of the present disclosure. As shown in FIG. 13, an audio signal processing system 10B according to the third embodiment is different from the audio signal processing system 10 according to the first embodiment in that a plurality of equalizers are additionally provided. Other configurations of the audio signal processing system 10B are the same as or similar to the configurations of the audio signal processing system 10, and a description of the same or similar configurations will be omitted.

The audio signal processing system 10B includes a plurality of equalizers EQ11 to EQ43. The plurality of equalizers EQ11 to EQ43 receive an input of the plurality of speaker supply signals Ss11 to Ss43 from the send level adjuster 12.

The plurality of equalizers EQ11 to EQ43 generate sound adjustment signals Sq11 to Sq43 by performing predetermined signal processing on each of the plurality of speaker supply signals Ss11 to Ss43. The plurality of equalizers EQ11 to EQ43 output the plurality of sound adjustment signals Sq11 to Sq43, respectively, to the plurality of output amplifiers A11 to A43.

By such a configuration and processing, the audio signal processing system 10B is able to emit a sound in a desired tone for each of the plurality of speakers, while producing the same functions and effects as the audio signal processing system 10.

It is to be noted that a parameter of the plurality of equalizers EQ11 to EQ43 may be set by an operation input of a conference manager or may be set by an operation input of each talker. Furthermore, the parameter of the plurality of equalizer EQ11 to EQ43 may be set based on the environment of a conference room, or the like.

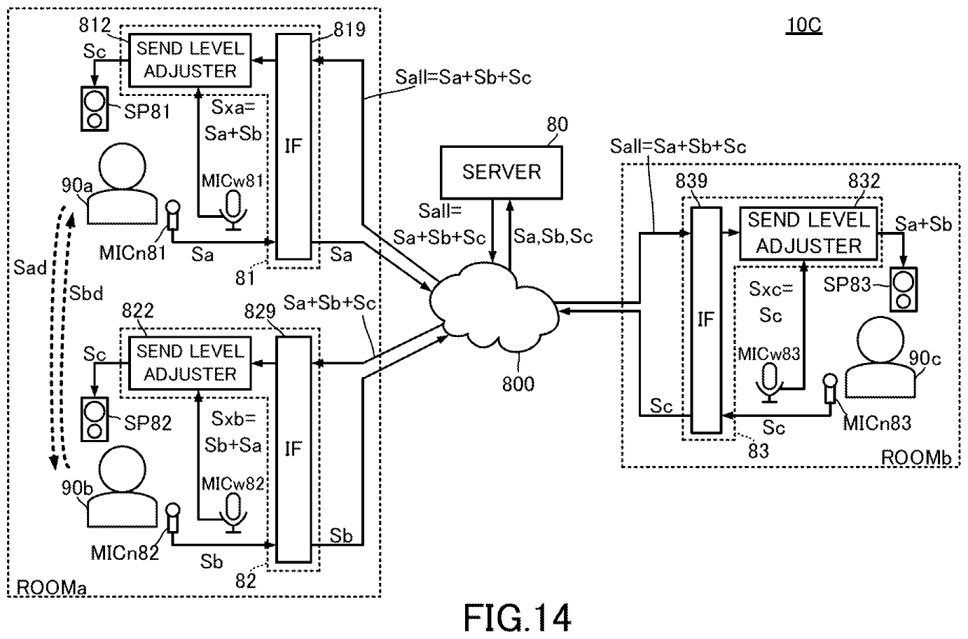

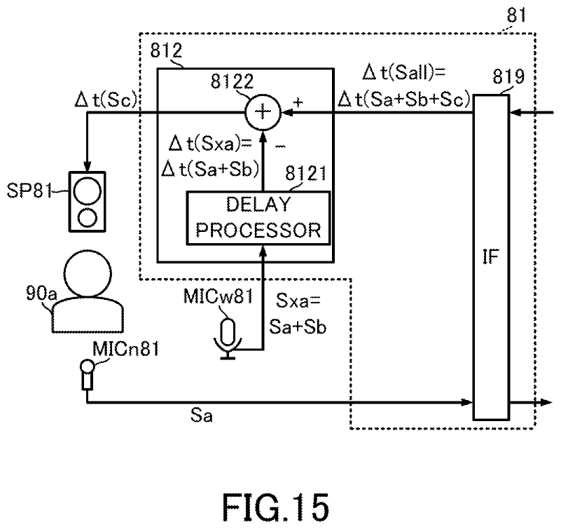

FIG. 14 is a functional block diagram showing an example of a configuration of an audio signal processing system according to a fourth embodiment of the present disclosure. FIG. 15 is a functional block diagram showing an example of a configuration of a conference apparatus used in an audio signal processing system according to the fourth embodiment.

The above first to third embodiments show a case in which a conference is held by all talkers gathering in one conference room (a physical space). The fourth embodiment shows a case in which a conference is held by talkers present in different conference rooms (different physical spaces). It is to be noted that the total number of talkers shown in the present embodiment and the number of talkers present in one conference room are examples and are not limited to this example.

As shown in FIG. 14, an audio signal processing system 10C includes a plurality of conference apparatuses 81 to 83, a plurality of speakers SP81 to SP83, a plurality of transmission microphones MICn81 to MICn83, a plurality of cancellation microphones MICw81 to MICw83, and a server 80. The transmission microphones each correspond to a “transmission sound collection apparatus” of the present disclosure, and the cancellation microphones each correspond to a “cancellation sound collection apparatus” of the present disclosure. In addition, these speakers each correspond to a “sound emission apparatus” of the present disclosure. The server 80 corresponds to a “transmission signal generator” of the present disclosure.

The plurality of conference apparatuses 81 to 83 and the server 80 are connected to a network 800 for communication. Accordingly, the plurality of conference apparatuses 81 to 83 and the server 80 perform data communication to each other through the network 800.

The conference apparatuses 81 and 82 are placed in a conference room ROOMa. The speakers SP81 and SP82, the transmission microphones MICn81 and MICn82, and the plurality of cancellation microphones MICw81 and MICw82 are placed in the conference room ROOMa. The speaker SP81, the transmission microphone MICn81, and the cancellation microphone MICw81 are connected to the conference apparatus 81. The speaker SP82, the transmission microphone MICn82, and the cancellation microphone MICw82 are connected to the conference apparatus 82.

The speaker SP81, the transmission microphone MICn81, and the cancellation microphone MICw81 are placed near a talker 90a. The conference apparatus 81 includes a send level adjuster 812 and an IF 819. The send level adjuster 812 and the IF 819 are connected to each other and are configured by an information processing apparatus in the same manner as each of the above embodiments. The IF 819 is connected to the server 80 through the network 800. The cancellation microphone MICw81 and the speaker SP81 are connected to the send level adjuster 812. The transmission microphone MICn81 is connected to the IF 819. The talker 90a holds a conference, using the speaker SP81, the transmission microphone MICn81, the cancellation microphone MICw81, and the conference apparatus 81.

The speaker SP82, the transmission microphone MICn82, and the cancellation microphone MICw82 are placed near a talker 90b. The conference apparatus 82 includes a send level adjuster 822 and an IF 829. The send level adjuster 822 and the IF 829 are connected to each other and are configured by an information processing apparatus in the same manner as each of the above embodiments. The IF 829 is connected to the server 80 through the network 800. The cancellation microphone MICw82 and the speaker SP82 are connected to the send level adjuster 822. The transmission microphone MICn82 is connected to the IF 829. The talker 90b holds a conference, using the speaker SP82, the transmission microphone MICn82, the cancellation microphone MICw82, and the conference apparatus 82.

The conference apparatus 83 is placed in a conference room ROOMb. The speaker SP83, the transmission microphone MICn83, and the cancellation microphone MICw83 are placed in the conference room ROOMb. The speaker SP83, the transmission microphone MICn83, and the cancellation microphone MICw83 are connected to the conference apparatus 83.

The speaker SP83, the transmission microphone MICn83, and the cancellation microphone MICw83 are placed near a talker 90c. The conference apparatus 83 includes a send level adjuster 832 and an IF 839. The send level adjuster 832 and the IF 839 are connected to each other and are configured by an information processing apparatus in the same manner as each of the above embodiments. The IF 839 is connected to the server 80 through the network 800. The cancellation microphone MICw83 and the speaker SP83 are connected to the send level adjuster 832. The transmission microphone MICn83 is connected to the IF 839. The talker 90c holds a conference, using the speaker SP83, the transmission microphone MICn83, the cancellation microphone MICw83, and the conference apparatus 83.

The sound collection directivity of the plurality of transmission microphones MICn81, MICn82, and MICn83 is narrow. Accordingly, the transmission microphone MICn81 collects the voice of the talker 90a, and hardly collects other voices. The transmission microphone MICn82 collects the voice of the talker 90b, and hardly collects other voices. The transmission microphone MICn83 collects the voice of the talker 90c, and hardly collects other voices.

The sound collection directivity of the plurality of cancellation microphones MICw81 to MICw83 is wider than the sound collection directivity of the plurality of transmission microphones MICn81 to MICn83. Accordingly, the cancellation microphone MICw81 collects not only the voice of the talker 90a but also the voice of the talker 90b. The cancellation microphone MICw82 collects not only the voice of the talker 90b but also the voice of the talker 90a. In other words, the cancellation microphones MICw81 and MICw82 collect a sound in a space at and around positions at which the talker 90a and the talker 90b are present. Similarly, the cancellation microphone MICw83 collects a sound in a space at and around a position at which the talker 90c in the conference room ROOMb is present.

By the above configuration, the audio signal processing system 10C executes processing of an audio signal in a conference as follows.

The transmission microphone MICn81 collects the voice of the talker 90a and generates a collected sound signal Sa. The transmission microphone MICn81 outputs the collected sound signal Sa to the IF 819 of the conference apparatus 81. The IF 819 sends the collected sound signal Sa to the server 80 through the network 800. The cancellation microphone MICw81 collects a sound in a space at and around positions at which the talker 90a and the talker 90b in the conference room ROOMa are present and generates a cancellation collected sound signal Sxa. The cancellation microphone MICw81 has wide directivity, so that the cancellation collected sound signal Sxa is a collected sound signal obtained by substantially adding the collected sound signal Sa of the voice of the talker 90a and the collected sound signal Sb of the voice of the talker 90b (Sxa=Sa+Sb).

The transmission microphone MICn82 collects the voice of the talker 90b and generates a collected sound signal Sb. The transmission microphone MICn82 outputs the collected sound signal Sb to the IF 829 of the conference apparatus 82. The IF 829 sends the collected sound signal Sb to the server 80 through the network 800. The cancellation microphone MICw82 collects a sound in a space at and around the positions at which the talker 90a and the talker 90b in the conference room ROOMa are present and generates a cancellation collected sound signal Sxb. The cancellation microphone MICw82 has wide directivity, so that the cancellation collected sound signal Sxb is a collected sound signal obtained by substantially adding the collected sound signal Sb of the voice of the talker 90b and the collected sound signal Sa of the voice of the talker 90a (Sxb=Sb+Sa).

The transmission microphone MICn83 collects the voice of the talker 90c and generates a collected sound signal Sc. The transmission microphone MICn83 outputs the collected sound signal Sc to the IF 839 of the conference apparatus 83. The IF 839 sends the collected sound signal Sc to the server 80 through the network 800. The cancellation microphone MICw83 collects a sound in a space at and around the position at which the talker 90c in the conference room ROOMb is present and generates a cancellation collected sound signal Sxc. Although the cancellation microphone MICw83 has wide directivity, only the talker 90c is present in the conference room ROOMb, so that the cancellation collected sound signal Sxc is substantially the collected sound signal Sc of the voice of the talker 90c (Sxc=Sc).

The server 80 adds the collected sound signal Sa, the collected sound signal Sb, and the collected sound signal Sc, and generates a voice addition signal Sall(=Sa+Sb+Sc). The server 80 sends the voice addition signal Sall to the plurality of conference apparatus 81 to 83 through the network 800. This voice addition signal Sall corresponds to a “transmission signal” of the present disclosure.

The IF 819 of the conference apparatus 81 receives the voice addition signal Sall and outputs the voice addition signal Sall to the send level adjuster 812.

As shown in FIG. 15, the send level adjuster 812 includes a delay processor 8121 and a subtractor 8122. The delay processor 8121 performs delay processing of delay amount Δt on the cancellation collected sound signal Sxa. The delay amount Δt in the conference apparatus 81 is set, for example, by time obtained by adding three of time to send the collected sound signal Sa from the conference apparatus 81 to the server 80, time to send the voice addition signal Sall from the server 80 to the conference apparatus 81, and time to generate the voice addition signal Sall in the server 80.

The delay processor 8121 outputs the cancellation collected sound signal Δt(Sxa) on which the delay processing has been performed, to the subtractor 8122. It is to be noted that the Δt(Sxa) shown in FIG. 15 means a signal Sxa(t+Δt) obtained by performing the delay processing of the delay amount Δt on a signal Sxa(t) of a time axis. The subtractor 8122 receives an input of the voice addition signal Sall from the IF 819. When inputted into the subtractor 8122, the voice addition signal Sall is delayed with respect to the collected sound signal Sa and the cancellation collected sound signal Sxa. The delay amount of this voice addition signal Sall is the same as the above delay amount Δt, and the subtractor 8122 receives an input of a voice addition signal Δt(Sall) having a delay. It is to be noted that the Δt(Sall) shown in FIG. 15 means a signal Sall(t+Δt) of the time axis. The subtractor 8122 subtracts the cancellation collected sound signal Δt(Sxa) on which the delay processing has been performed, from the voice addition signal Δt(Sall) having a delay. The voice addition signal Sall is a signal obtained by adding the collected sound signal Sa, the collected sound signal Sb, and the collected sound signal Sc, and the cancellation collected sound signal Sxa for is a signal obtained by adding the collected sound signal Sa and the collected sound signal Sb. The Δt(Sxa)=Δt(Sa+Sb) shown in FIG. 15 means the signal Sxa(t+Δt)=Sa(t+Δt)+Sb(t+Δt) of the time axis. The Δt(Sall)=Δt(Sa+Sb+Sc) shown in FIG. 15 means the signal Sall(t+Δt)=Sa(t+Δt)+Sb(t+Δt)+Sc(t+Δt) of the time axis.

Therefore, an output signal from the subtractor 8122 is a signal obtained by reducing the collected sound signal Sa and the collected sound signal Sb, which is a sound emission signal Δt(Sc). The Δt(Sc) shown in FIG. 15 means a signal Sc(t+Δt) of the time axis. The subtractor 8122 sends (outputs) the sound emission signal Δt(Sc) to the speaker SP81. Accordingly, the sound emission signal Δt(Sc) to be sent from the send level adjuster 812 to the speaker SP81 is a signal adjusted so that the send level of the collected sound signal Sa and the collected sound signal Sb may be the minimum.

The speaker SP81 emits a sound of the sound emission signal Δt(Sc), and the talker 90a hears this sound. As a result, the talker 90a can hear only the voice of the talker 90c in another conference room ROOMb, from the speaker SP81.

The IF 829 of the conference apparatus 82 receives the voice addition signal Sall and outputs the voice addition signal Sall to the send level adjuster 822. The send level adjuster 822 includes the same configuration as the send level adjuster 812. As a result, the talker 90b can hear only the voice of the talker 90c in another conference room ROOMb, from the speaker SP82.

Herein, the talker 90a and the talker 90b who are present in the conference room ROOMa directly hear each voice. For example, as shown in FIG. 14, the talker 90a directly hears the voice Sbd of the talker 90b. Similarly, the talker 90b directly hears the voice Sad of the talker 90a. In contrast, by the above processing, the talker 90a and the talker 90b who are present in the conference room ROOMa do not hear the voice of each partner from the speaker SP81 and the speaker SP82.

Therefore, the talker 90a and the talker 90b are significantly reduced from doubly hearing voices each other by a time lag. As a result, the audio signal processing system 10C is able to provide a comfortable conference environment to a plurality of talkers in the same room in a Web conference.

In addition, the audio signal processing system 10C, similarly to the audio signal processing system 10, does not emit a sound of the collected sound signal of this microphone from the speaker closest to the microphone into the same room, which is able to significantly reduce howling. As a result, in the conference room ROOMa in which the plurality of talkers 90a and 90b are present, and the plurality of microphones MICn81 and MICn82 and the plurality of speakers SP81 and SP82 are placed, the audio signal processing system 10C is able to significantly reduce howling of the voice of the talker 90a and howling of the voice of the talker 90b.

In such a case, the send level adjuster, since being configured by the delay processor and the subtractor, is able to significantly reduce howling, with a simple configuration and processing. Therefore, the audio signal processing system 10C, similarly to the audio signal processing system 10, is able to significantly reduce howling without requiring complex signal processing and appropriately output a voice other than the voice of which the howling is to be significantly reduced.

The IF 839 of the conference apparatus 83 receives the voice addition signal Sall and outputs the voice addition signal Sall to the send level adjuster 832. The send level adjuster 832 includes the same configuration as the send level adjuster 812.

Therefore, an output signal from the send level adjuster 832 is a signal obtained by subtracting the cancellation collected sound signal Sxc on which the delay processing has been performed, from the voice addition signal Δt(Sall) having a delay. Accordingly, the output signal from the send level adjuster 832 is a signal obtained by reducing the collected sound signal Sc, which is a sound emission signal Δt(Sa+Sb). The send level adjuster 832 sends (outputs) the sound emission signal Δt(Sa+Sb) to the speaker SP83. Accordingly, the sound emission signal Δt(Sa+Sb) to be sent from the send level adjuster 832 to the speaker SP83 is a signal adjusted so that the send level of the collected sound signal Sc may be the minimum.

The speaker SP83 emits a sound of the sound emission signal Δt(Sa+Sb), and the talker 90c hears this sound. As a result, the talker 90c can hear the voice of the talker 90a and the voice of the talker 90b in another conference room ROOMa, from the speaker SP83.

In addition, similarly to the conference room ROOMa, in the conference room ROOMb in which the plurality of talkers 90c and the microphone MICn83 and the speaker SP83 are placed, the audio signal processing system 10C is able to significantly reduce howling of the voice of the talker 90c. The audio signal processing system 10C, in the conference room ROOMb as well, is able to significantly reduce howling without requiring complex signal processing and appropriately output a voice other than the voice of which the howling is to be significantly reduced.

It is to be noted that the audio signal processing system of each of the above embodiments shows an aspect in which the second speaker is set. However, the audio signal processing system is also able to set only the first speaker and omit setting of the second speaker. In addition, in the audio signal processing system of each of the above embodiments, the number of second speakers that have been set is not limited to two and may be one, or three or more according to the placement of the plurality of speakers, or the like. Moreover, the audio signal processing system may adjust the send level to be subtracted from a reference send level for each of the plurality of speakers, according to a distance from the microphone that collects the voice of a talker.

In addition, each of the above embodiments shows a case in which the microphone is of a mounted type. In other words, each of the above embodiments shows a case in which the microphone does not move. However, the microphone (the microphone for generating a collected sound signal), when moving with a talker like a pin microphone, is able to apply the above configuration. In such a case, the audio signal processing system may include the following configuration, for example.

The audio signal processing system includes a configuration that detects a position of the talker (the microphone for generating a collected sound signal). In addition, the audio signal processing system stores positions of the plurality of speakers. The audio signal processing system calculates a distance between the microphone for generating a collected sound signal and the plurality of speakers, from the position of the detected talker (the microphone for generating a collected sound signal). The audio signal processing system determines a speaker closest to the microphone for generating a collected sound signal as the first speaker and determines a speaker second closest to the microphone as the second speaker. Hereinafter, the audio signal processing system adjusts the send level as described above. As a result, the audio signal processing system is able to significantly reduce howling without requiring complex signal processing and appropriately output a voice other than a voice of which the howling is to be significantly reduced.

In addition, each of the above embodiments shows a case in which the plurality of microphones and the plurality of speakers are placed separately. However, each of the plurality of microphones and the speaker (the first speaker) closest to each microphone may be placed integrally. For example, each of the plurality of microphones and the speaker (the first speaker) closest to each microphone may be housed in one housing. As a result, the positional relationship between each of the plurality of microphones and the speaker (the first speaker) closest to each microphone is fixed. Therefore, the audio signal processing system is able to more reliably significantly reduce howling.

The description of the present embodiment is illustrative in all points and should not be construed to limit the present disclosure. The scope of the present disclosure is defined not by the foregoing embodiments but by the following claims. Further, the scope of the present disclosure is intended to include all modifications within the scopes of the claims and within the meanings and scopes of equivalents.

What is claimed is:

1. An audio signal processing method comprising:
providing a plurality of sound collection apparatuses and a plurality of sound emission apparatuses corresponding to the plurality of sound collection apparatuses; and
performing send level adjustment processing that sets a level of an audio signal of a sound collected by the plurality of sound collection apparatuses to a preset send level and sends the audio signal to the plurality of sound emission apparatuses, wherein
the send level adjustment processing changes a first send level to a minimum, the first send level being sent from a first sound collection apparatus that detects a talker voice, among the plurality of sound collection apparatuses, to a first sound emission apparatus closest to the first sound collection apparatus.

2. The audio signal processing method according to claim 1, wherein:
the send level adjustment processing reduces a second send level of an audio signal to be sent to a second sound emission apparatus second closest to the first sound collection apparatus after the first sound emission apparatus; and
the first send level is smaller than the second send level.

3. The audio signal processing method according to claim 1, further comprising: processing that adds an indirect sound to each of a plurality of audio signals of sounds collected by the plurality of sound collection apparatuses.

4. The audio signal processing method according to claim 3, wherein the processing that adds an indirect sound adds different indirect sounds to respective audio signals of sounds to be collected by the plurality of sound collection apparatuses.

5. The audio signal processing method according to claim 1, wherein the plurality of sound collection apparatuses and the plurality of sound emission apparatuses have integrated shapes each including a pair of a sound collection apparatus and a sound emission apparatus.

6. The audio signal processing method according to claim 1, further comprising: detecting a voice of a when an audio signal of a specified level or above is inputted.

7. An audio signal processing method comprising:
providing a plurality of sound collection apparatuses; and
providing a plurality of sound emission apparatuses, wherein the plurality of sound collection apparatuses include:
a transmission sound collection apparatus; and
a cancellation sound collection apparatus having a wider directivity than transmission sound collection apparatus,
set a level of an audio signal of a sound collected by the transmission sound collection apparatus to a preset send level,
send the audio signal to the plurality of sound emission apparatuses, cancel the audio signal of sound collected by the cancellation sound collection apparatus from audio signals received by each sound emission apparatus of the plurality of sound emission apparatuses, and
output the canceled audio signal to the sound emission apparatus.

8. An audio signal processing system comprising:
a plurality of sound collection apparatuses;
a plurality of sound emission apparatuses corresponding to the plurality of sound collection apparatuses; and
a send level adjuster that sets a level of an audio signal of a sound collected by the plurality of sound collection apparatuses to a preset send level and sends the audio signal to the plurality of sound emission apparatuses, wherein
the send level adjuster changes a first send level to a minimum, the first send level being sent from a first sound collection apparatus that detects a talker voice, among the plurality of sound collection apparatuses, to a first sound emission apparatus closest to the first sound collection apparatus.

9. The audio signal processing system according to claim 8, wherein:
the send level adjuster reduces a second send level of an audio signal to be sent to a second sound emission apparatus second closest to the first sound collection apparatus after the first sound emission apparatus; and
the first send level is smaller than the second send level.

10. The audio signal processing system according to claim 8, wherein the send level adjuster adds an indirect sound to each of a plurality of audio signals of sounds collected by the plurality of sound collection apparatuses.

11. The audio signal processing system according to claim 10, wherein the send level adjuster adds different indirect sounds to the respective audio signals of sounds to be collected by the plurality of sound collection apparatuses.

12. The audio signal processing system according to claim 8, wherein the plurality of sound collection apparatuses and the plurality of sound emission apparatuses have integrated shapes each including a pair of a sound collection apparatus and a sound emission apparatus.

13. The audio signal processing system according to claim 8, further comprising: a detector that detects a voice of a talker when an audio signal of a specified level or above is inputted, wherein the send level adjuster performs send level adjustment processing to the talker voice detected by the detector.
